(19) United States
(12) Patent Application Publication
(10) Pub. No.: US 2012/0316888 A1
(43) Pub. Date: Dec. 13, 2012

(54) APPARATUS AND METHOD FOR ISSUING A NEWS RELEASE WHILE FILING AN SEC FILING

(75) Inventor: Jeffrey S STACEY, Rancho Palos Verdes, CA (US)

(73) Assignee: THE NASDAQ OMX GROUP, INC., New York, NY (US)

(21) Appl. No.: 13/155,951

(22) Filed: Jun. 8, 2011

(51) Int. Cl. G06Q 99/00

(52) U.S. Cl. 705/1.1

(57) ABSTRACT

An apparatus and method provide for simultaneous issuance of a news release with the submission and filing of an SEC EDGAR filing. A news release disclosing an event related to an organization and containing a material disclosure is generated. Once the news release is generated, the issuance of the news release to a news release distribution source is scheduled. A description of contents of the news release to be placed in an EDGAR filing are then generated and the EDGAR filing is filed while issuing the news release to the news release distribution source. The apparatus and method offer truly simultaneous news release distribution at the same time that an EDGAR filing is made.

### TECHNICAL FIELD

The technical field relates to news release distribution systems.

### BACKGROUND

Publicly-traded companies listed on a U.S. stock exchange are required by Security and Exchange Commission (SEC) regulations to announce material financial news to the public on a simultaneous, non-exclusionary basis. The process of announcing a material financial event to the public is called “disclosure,” and publicly-traded companies must interpret numerous, overlapping regulations that mandate the use of SEC filings, press releases, and in some situations, the company's corporate website as a vehicle for disclosing a material event to the public.

The corporation employees and/or officers typically collaborate to form a “disclosure” policy, and then choose a “disclosure channel” (i.e., SEC filing, press release, website posting, etc.) for each type of material event. When choosing a disclosure channel, the corporation issuing the disclosure must carefully consider SEC regulations mandating “simultaneous” notice to the public on a fair, non-exclusionary basis.

An example of an event that should be simultaneously disclosed to the public is the departure of a Chief Executive Officer (CEO). The SEC has several forms for recording these events, and in the instance of a CEO leaving a corporation, the corporation should file a Current Report on a Form 8-K within four business days of the event. The Form 8-K generally consists of a name and description of the event that contains all information that the company considers relevant to shareholders and the SEC, and also any exhibits that are relevant (i.e., financial statements, press releases, data tables, etc.). The Form 8-K is filed with the SEC using the Electronic Data-Gathering, Analysis, and Retrieval (EDGAR) system. The EDGAR system performs automated collection, validation, indexing, acceptance, and forwarding of submissions by companies and others who are required by law to file forms with the SEC and is freely available to the public via the Internet.

The SEC requires “simultaneous” disclosure of the material events with the filing of the various forms. In the example of a departing CEO, the Form 8-K would ideally be filed around the same time that the corporation issues a press release so that the formal information is submitted to the SEC at the same time that it is announced to the public.

There are currently self-service, template-driven EDGAR filing solutions available where a Form 8-K or Form 6-K may be prepared and submitted to the SEC by the corporation issuing the news release, without any intervention or assistance from a service provider. These services gather the relevant data for the filing and generate a compliant SEC EDGAR filing relating to the nature of the information filed.

However, these systems perform the EDGAR filing independent from the news release distribution and therefore do not offer true simultaneous news release distribution with the EDGAR filing. Likewise, these systems do not facilitate the automatic submission of the news release to be submitted as an exhibit with the EDGAR filing. As such, the news release is not issued simultaneously with the EDGAR filing; nor is there consistency between the content of the news release and the EDGAR filing. What is needed is technology that provides truly simultaneous news release distribution while performing an EDGAR filing.

### SUMMARY

An electronic filing method is provided for performing an EDGAR filing while simultaneously issuing a news release. A news release disclosing an event related to an organization and containing a material disclosure is generated. Once the news release is generated, the issuance of the news release to a news release distribution channel is scheduled. A description of contents of the news release to be placed in an EDGAR filing are then generated and the EDGAR filing is filed while issuing the news release to the news release distribution channel.

A non-transitory computer-readable storage medium is disclosed having computer readable code embodied therein is provided for executing the electronic filing method described in the preceding paragraph.

Another aspect relates to an electronic filing apparatus having a memory that stores a news release and a description of the contents of the news release and electronic circuitry, coupled to the memory, for performing an EDGAR filing while issuing the news release. The electronic circuitry is programmed to: generate the news release disclosing an event related to an organization, the news release containing a material disclosure, schedule an issuance of the news release to a news release distribution channel, generate the description of the contents of the news release to be placed in an EDGAR filing, and file the EDGAR filing while issuing the news release to the news release distribution channel.

Yet another aspect relates to an electronic filing apparatus having a memory that stores a news release and a description of the contents of the news release and a data processor, coupled to the memory, for performing an EDGAR filing while issuing the news release. The data processor is programmed to: generate the news release disclosing an event related to an organization, the news release containing a material disclosure, select one or more recipients to receive the news release, select one or more news release distribution channels to distribute the news release, schedule a distribution of the news release to the one or more news release distribution channels, generate the description of the contents of the news release to be placed in an EDGAR filing, and file the EDGAR filing while distributing the news release to the one or more news release distribution channels, the EDGAR filing is simultaneously filed when distributing the news release.

In a non-limiting example implementation, the EDGAR filing may be scheduled to file at a first selected time and the issuance of the press release may be scheduled to issue at a second selected time, the first selected time being different from the second selected time.

In another non-limiting example implementation, a copy of the news release is attached to the EDGAR filing as an exhibit, and the news release contains at least one of a release text, or classification codes, or keywords, or a combination thereof.

In yet another non-limiting example implementation, the EDGAR filing includes an item category and item text. The item category is one of several predefined category codes. The item text is one or more paragraphs containing the description of the contents of the news release. Each EDGAR filing is generated based on a template for a type of EDGAR filing. The template is automatically customized based on the item category. The template is populated with the item text.

### BRIEF DESCRIPTION OF THE DRAWINGS

FIG. 1 illustrates an example of a system block diagram for a news release system that simultaneously performs an EDGAR filing;

FIG. 2 illustrates an example of a process overview of a system that issues a news release while simultaneously performing an EDGAR filing;

FIG. 3 illustrates an example of a flowchart for a news release system that simultaneously performs an EDGAR filing;

FIG. 4 illustrates an example of a distribution engine for the news release system;

FIG. 5 illustrates an example of a screenshot for submitting an EDGAR filing in the news release system;

FIG. 6 illustrates an example of a screenshot for scheduling the news release and the EDGAR filing; and

FIG. 7 illustrates an example of a news release generated by the news release system.

### DETAILED DESCRIPTION

In the following description, for purposes of explanation and non-limitation, specific details are set forth, such as particular nodes, functional entities, techniques, protocols, standards, etc. in order to provide an understanding of the described technology. It will be apparent to one skilled in the art that other embodiments may be practiced apart from the specific details described below. In other instances, detailed descriptions of well-known methods, devices, techniques, etc. are omitted so as not to obscure the description with unnecessary detail. Individual function blocks are shown in the figures. Those skilled in the art will appreciate that the functions of those blocks may be implemented using individual hardware circuits, using software programs and data in conjunction with a suitably programmed microprocessor or general purpose computer, using applications specific integrated circuitry (ASIC), and/or using one or more digital signal processors (DSPs). The software program instructions and data may be stored on computer-readable storage medium and when the instructions are executed by a computer or other suitable processor control, the computer or processor performs the functions. Although databases may be depicted as tables below, other formats (including relational databases, object-based models and/or distributed databases) may be used to store and manipulate data.

Although process steps, algorithms or the like may be described or claimed in a particular sequential order, such processes may be configured to work in different orders. In other words, any sequence or order of steps that may be explicitly described or claimed does not necessarily indicate a requirement that the steps be performed in that order. The steps of processes described herein may be performed in any order possible. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention(s), and does not imply that the illustrated process is preferred. A description of a process is a description of an apparatus for performing the process. The apparatus that performs the process may include, e.g., a processor and those input devices and output devices that are appropriate to perform the process.

Various forms of computer readable media may be involved in carrying data (e.g., sequences of instructions) to a processor. For example, data may be (i) delivered from RAM to a processor; (ii) carried over any type of transmission medium (e.g., wire, wireless, optical, etc.); (iii) formatted and/or transmitted according to numerous formats, standards or protocols, such as Ethernet (or IEEE 802.3), SAP, ATP, Bluetooth, and TCP/IP, TDMA, CDMA, 3G, etc.; and/or (iv) encrypted to ensure privacy or prevent fraud in any of a variety of ways well known in the art.

The technology in this application may be used in any type of EDGAR filing system. The EDGAR filing system is an electronic system that automates submissions by companies that are required by law to file forms with the SEC. One example form is a Form 6-K which is an SEC filing used by certain foreign private issuers to provide information that is required to be made public in the country of its domicile, filed with and made public by a foreign stock exchange on which its securities are traded, or are distributed to security holders. Another example form is a Form 8-K which is a form used to notify investors of any material event that is important to shareholders or the SEC. Some examples of material events are when a director is elected (or when a director departs), asset movement (acquisition or sale), or modifications to shareholders rights. As mentioned above, these forms should be filed simultaneously with the event or with the public news release of the event.

The inventor recognized that current systems for performing EDGAR filings are not based on a news release and that news release distribution and the EDGAR filing are not performed simultaneously. In a non-limiting, example embodiment, an electronic news distribution system provides news release distribution services used by a wide variety of organizations to make announcements that may be of interest to various constituents, including members of the media, financial service providers, regulatory agencies, customers, partners, shareholders, and others. Publicly traded companies may use the applicant's news distribution system to make routine, non-financial announcements, as well as material financial news that must be disclosed to the public in a manner that fulfills regulatory obligations defined by the SEC.

A user of the news release distribution system may complete a list of tasks associated with the news release. Although not limited to this list of tasks, some of the tasks that may be performed by the user are entering news release text, including headline, body, and media contacts, selecting codes used to classify the subject matter of the news release, entering keywords used to summarize the most relevant or primary topic, and specifying a disclosure schedule as a date, time, and time zone.

If the news release includes a material financial announcement, and the user wishes to file the news release with the SEC, the user may then add further pieces of information, such as, for example, an 8-K item category and item text in addition to the information provided in the news release. The item category may be one of “n” category codes specified by the SEC, and the item text may be one or more paragraphs of text used by the user issuing the news release to describe the contents of the news release. This system allows a user to use the information gathered and entered to automatically generate a fully-compliant SEC EDGAR filing by automatically populating the entered information into a previously-configured template. At the same time, the same news release may be scheduled for concurrent distribution across the news release distribution system. The material event is thus disclosed to the public and simultaneously filed with the SEC.

The news release distribution system may simultaneously distribute news releases across multiple distribution channels. For example, a single news release may be submitted to the SEC through the EDGAR filing method, displayed on the company's web-site, and distributed across a newswire network. This allows a user to once again perform the SEC filing while simultaneously distributing the news release across multiple news distribution channels. This also ensures that a single version of the news release is submitted to the SEC and distributed across the multiple news distribution channels, thereby ensuring the submission and distribution of a uniform, single news release.

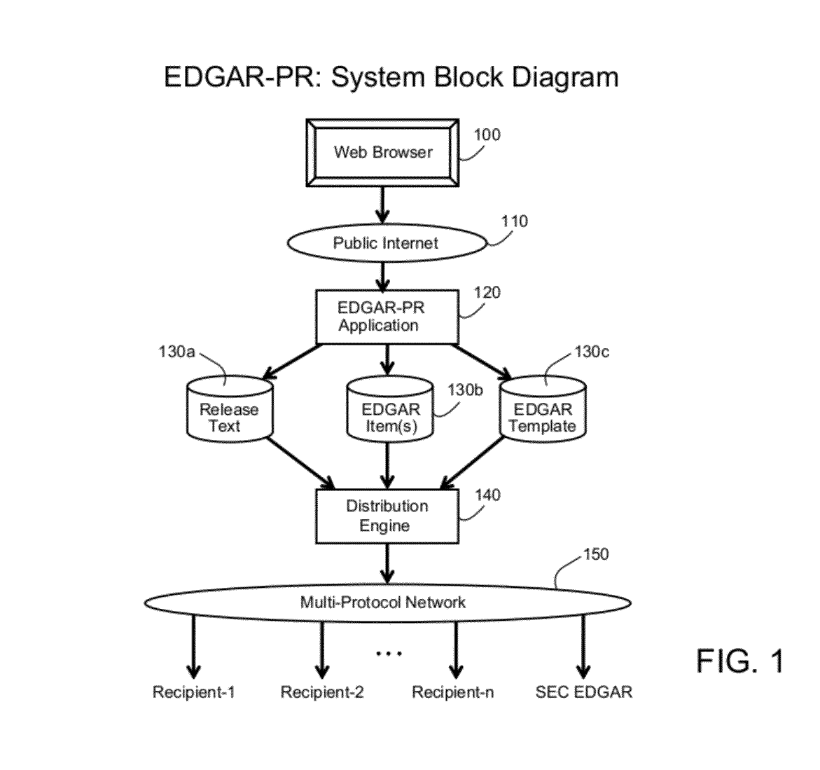

FIG. 1 shows a block diagram for a non-limiting, example news release system. A user may enter news release information using, for example, a web browser 100 that transmits the information across the Internet 110. The user may use the web browser to access the news release application 120 where the user may enter a news release for distribution while simultaneously filing an EDGAR filing.

The news release application 120 stores several items of information related to both the news release and the EDGAR filing. The items of information include, but are not limited to, release text 130a, EDGAR items 130b, and an EDGAR template 130c. The release text 130a is the substance of the news release that the user wishes to convey through the distribution channels. The EDGAR items 130b are also preferably entered by the user and may consist of an item category, which may be one of “n” category codes specified by the SEC, and item text, which may be one or more paragraphs of text used by the user issuing the news release to describe the contents of the news release. The EDGAR template 130c is a fully compliant SEC EDGAR filing template that is automatically populated with information entered and stored in the EDGAR items 130b and is based off the release text 130a. For example, an 8-K template would be a previously configured template for a Form 8-K as set out by the SEC and the system would populate that template using the EDGAR items 130b and the release text 130a.

Once the user has entered in all of the necessary information for the news release and the EDGAR filing, the distribution engine 140 distributes the news release and submits the EDGAR filing across the multi-protocol network 150. The distribution engine 140 may distribute the news release across multiple distribution channels while simultaneously submitting the EDGAR filing to the SEC. The news release application 120, the release text 130a, the EDGAR items 130b, the EDGAR template 130c, and the distribution engine 140 may all be implemented on a single computer or may be alternatively implemented across several computers.

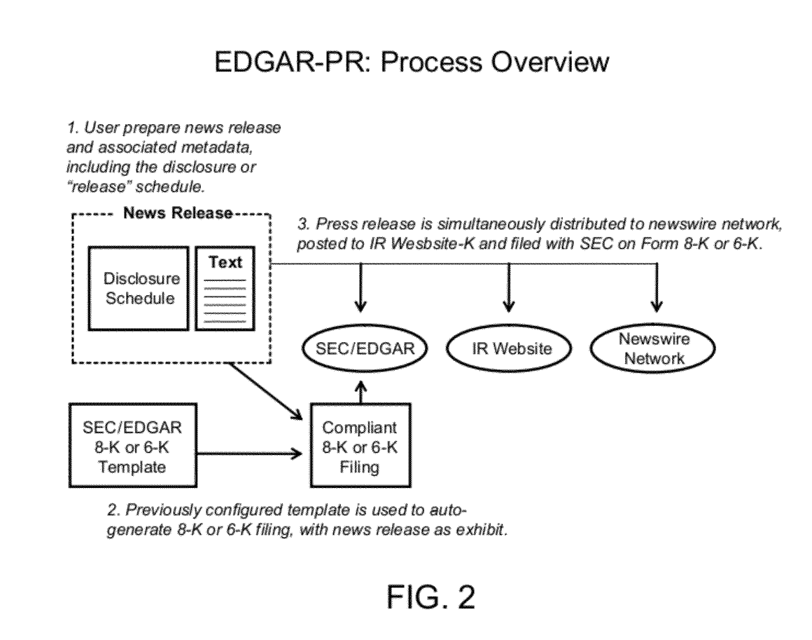

FIG. 2 shows an example of a process overview for the news release distribution system. While preparing a news release, a user may also schedule the time in which to issue the news release. Although not limited to this embodiment, the user may issue the news release simultaneously across multiple distribution channels.

If the information in the news release is related to a material event, the user may choose to also perform an EDGAR filing with the SEC. If the user files an EDGAR filing along with the news release distribution, a previously generated template is populated based on the news release and the item category and item text provided in the EDGAR items. This information is placed into the template so that a compliant SEC filing may be submitted via the EDGAR system. The news release itself may also be included as an exhibit to be submitted with the EDGAR filing. Therefore, a single news release may be submitted to the SEC, posted to the company's web-site, and distributed across the newswire network, all using a single distribution method. Using the single news release is advantageous because it provides a uniform distribution of a single news release across multiple distribution channels.

The news release system is preferably implemented in a computer environment. For example, the news release system can be implemented using one or more computer servers having processors and memory that store and execute the news release application, store data related to the news release distribution, and electronically distribute the news releases to the one or more parties.

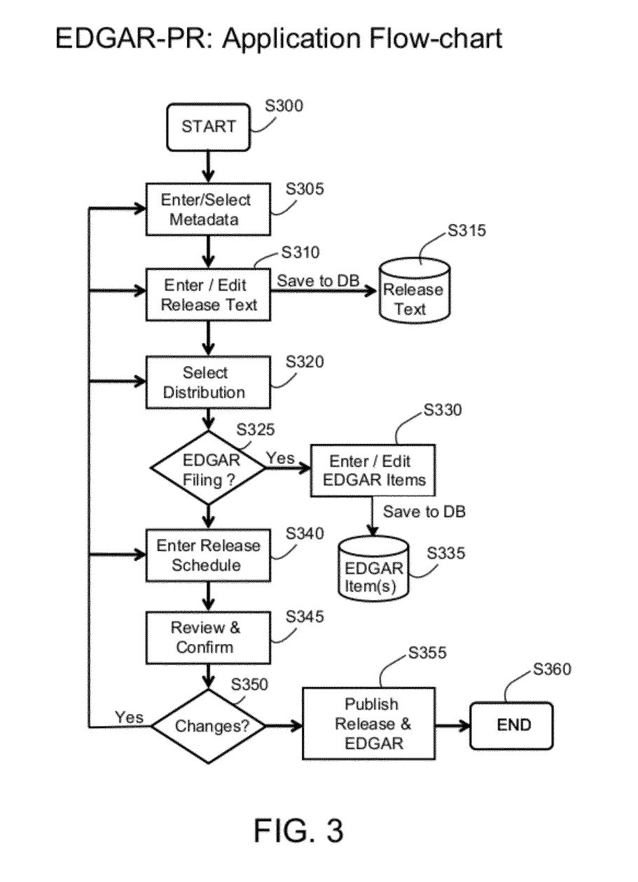

FIG. 3 shows an example of an application flowchart for the news release system. It should be appreciated that the steps listed below can be executed in any given order and are not limited to the order explained herein.

The system begins at step S305 where a user enters or selects the appropriate metadata. The user may then enter and/or edit the release text at step S310 using an inputting device for entering data. For example, the user could enter the input using a standard keyboard connected to the computer that is using the news release system. The release text is the substance of the news release that the user intends to distribute and disclose to the public. After the release text is entered and/or edited, the release text may be saved in a database in step S315.

After the user enters the release text, the user may then select the distribution channels in step S320. The distribution channels refer to one or more individuals to receive the news release and/or one or more distribution mediums in which the information will be distributed to the public. For example, a distribution channel could be an individual (i.e. a stock holder) or a medium to distribute information (i.e. a company web-site).

After the user selects the one or more distribution channels to convey the information in the news release, the system determines if the user wants to submit an EDGAR filing with the news release distribution in step S325. If the user does not want to submit an EDGAR filing, the system proceeds to step S340 where the user may enter the news release schedule, as described below.

If the user chooses to submit an EDGAR filing, the system proceeds to step S330 where the user may enter and/or edit the EDGAR filing items. Although not limited to this embodiment, the user enters an item category, which is one of “n” category codes specified by the SEC, and item text, which is one or more paragraphs of text used by the user to describe the contents of the news release. Once the user provides the item category and the item text, the system saves the information in a database in step S335.

The system then advances to step S340 where the user may enter the release schedule. Although not limited to this embodiment, the user may schedule the news release so that the news release is distributed across multiple distribution channels at the same time. For example, the user may schedule the news release to post to the company's web-site, distribute across a newswire network, and submit the news release to the SEC in an EDGAR filing using the appropriate SEC forms.

Once the release schedule has been set by the user, the system proceeds to step S345 where the user may review and confirm all of the information that has been entered. If there are any changes that need to be made, the user may edit any of the information entered in steps S310, S320, S330, and S340.

Once the user is satisfied with the entered information, the system proceeds to step S355 where the news release is issued and the EDGAR filing is submitted. Although not limited to this embodiment, the news release will be distributed across all of the selected distribution channels simultaneous with submitting the EDGAR filing to the SEC. In another example embodiment, the user may choose to submit the EDGAR filing at another time that is different then the time selected for distributing the news release. For example, the user may select to submit that EDGAR filing an hour after the news release has been distributed.

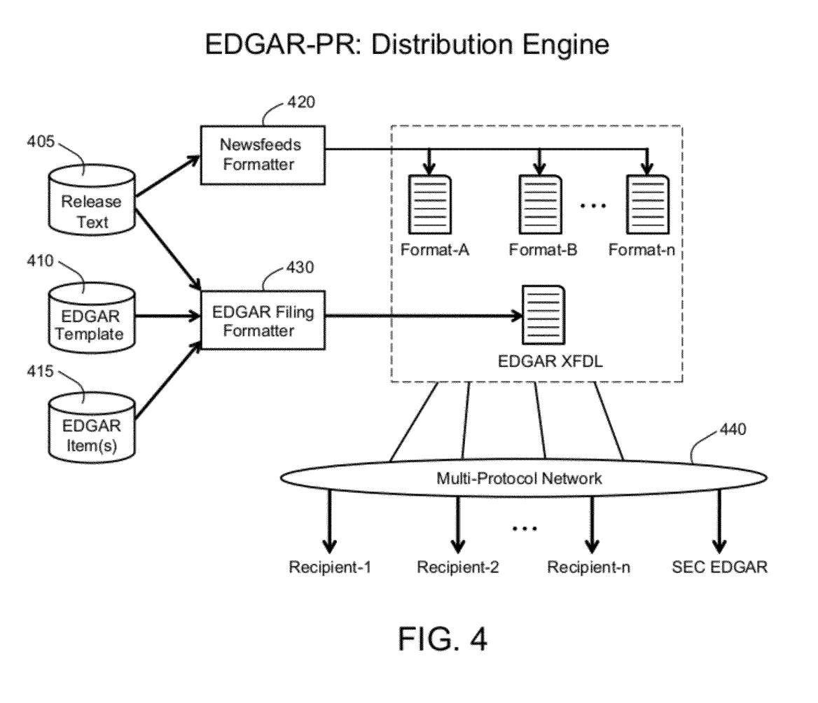

FIG. 4 shows a detailed view of the distribution engine 140 of FIG. 1. Although not limited to this embodiment, the distribution engine 140 has both a newsfeed formatter 420 for formatting the newsfeed based on the particular distribution channel and an EDGAR filing formatter 430 for formatting the filing based on the appropriate filing form.

The release text 405 is the substance of the news release as entered by the user and is provided to both the newsfeed formatter 420 and the EDGAR filing formatter 430. The EDGAR template 410 holds several different templates for pertaining to a respective EDGAR filing. For example, the EDGAR template 410 contains a template for a Form 6-K filing and a template for a Form 8-K filing. The EDGAR items 415 are the supplemental items of information entered by the user that are specific to the EDGAR filing. Although not limited to this embodiment, the EDGAR items 415 are an item category, which is one of “n” category codes specified by the SEC, and item text, which is one or more paragraphs of text used by the user to describe the contents of the news release.

The newsfeed formatter 420 formats the release text 405 into an appropriate format for distribution. The newsfeed formatter 420 may format the release text 405 into one or more different formats to be distributed across multiple distribution channels. For example, the newsfeed formatter 420 may format the release text 405 in a format displayable on a web-site and may format the release text 405 in a format displayed over a newswire network.

The EDGAR filing formatter 430 likewise formats the entered information to conform to the necessary standard for an EDGAR filing. The EDGAR filing formatter 430 populates the appropriate EDGAR template taken from the EDGAR template 410 by using both the information in the release text 405 and the information in the EDGAR items 415. The information is then properly formatted by the EDGAR filing formatter 430 into the necessary standard for an EDGAR filing. For example, a user may want to file a Form 8-K along with a news release disclosing the departure of the company's Chief Executive Officer. The EDGAR filing formatter 430 chooses the template for an 8-K filing from the EDGAR template 410 and then populates the template with the release text 405 and the EDGAR items 415.

Once the newsfeed formatter 420 has properly formatted the release text 405 for distribution across several different news release formats, and once the EDGAR filing formatter 430 has populated the EDGAR template 410 with the release text 405 and the EDGAR items 415, the respective forms are distributed across the multi-protocol network 440. The multi-protocol network 440 distributes the news release to the intended recipient in the appropriate format for the recipient. It should also be noted that the news release may be attached as an exhibit with the EDGAR filing.

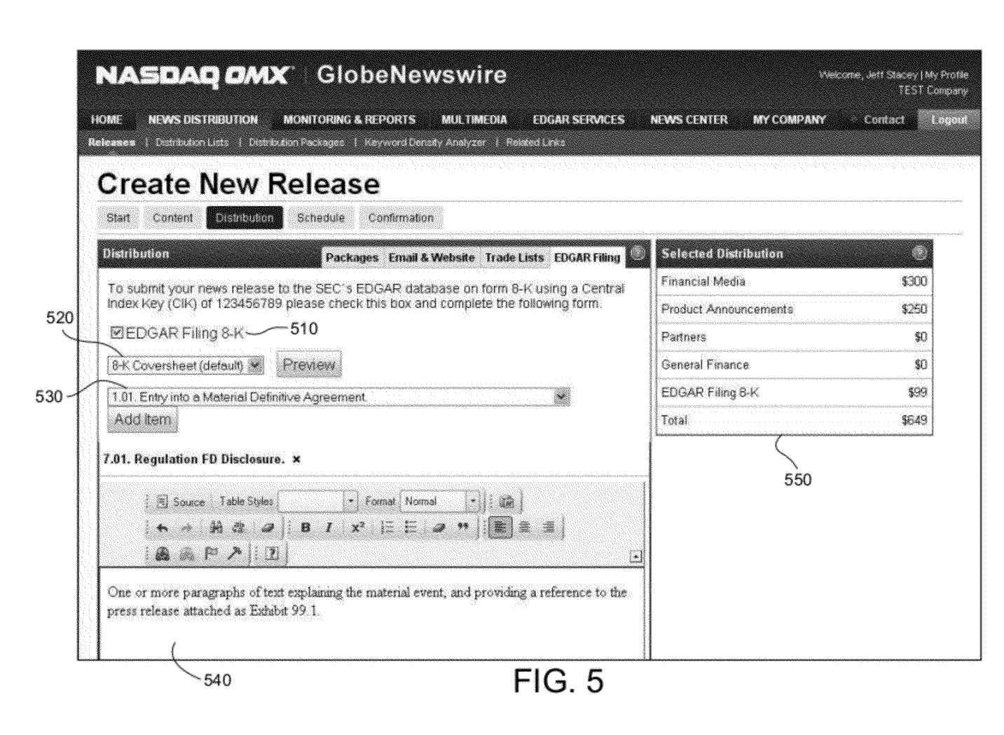

FIG. 5 shows an example screen shot for creating an EDGAR filing with a news release. The example shown in FIG. 5 shows the EDGAR Filing 8-K box 510 is selected. The cover sheet selector 520 allows the user to select the appropriate cover sheet for the EDGAR filing. The user may then select the item category 530 and enter the item text in the item text entry portion 540. In addition to selecting an item category 530 and entering item text into the item text entry portion 540, the user may also submit the news release as an exhibit with the filing. The selected distribution portion 550 shows the different parties that the user intends to distribute the news release. The example shown in FIG. 5 shows that, among other recipients, the user will distribute to partners, general finance, and will submit an EDGAR filing 8-K.

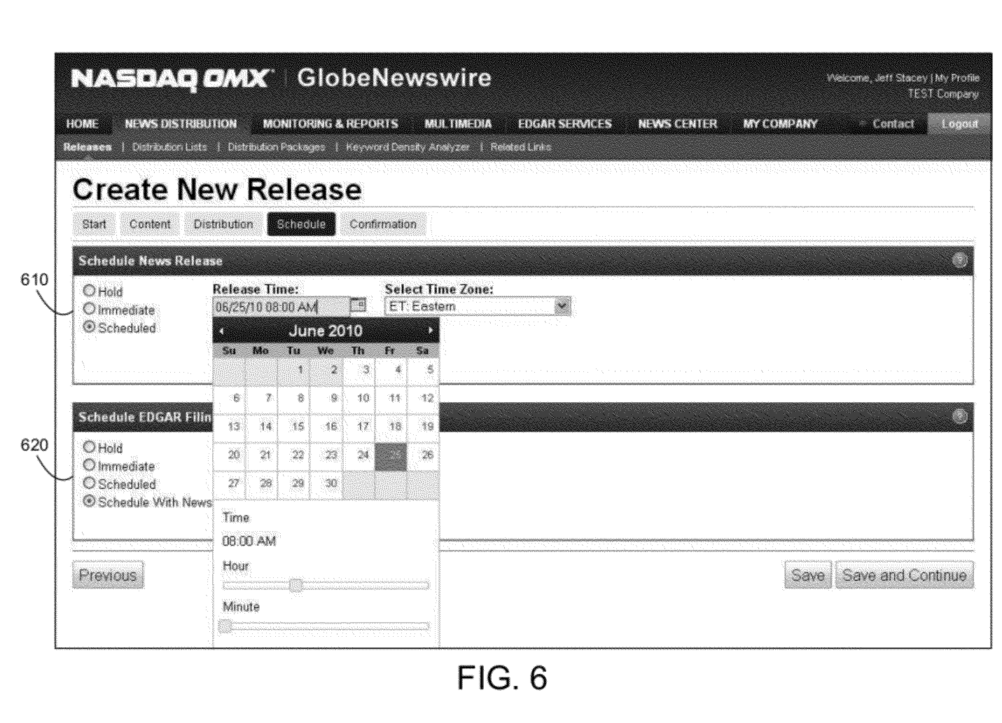

FIG. 6 shows an example of a screen shot for allowing a user to schedule the time to issue the news release and for allowing the user to schedule the EDGAR filing. In the news release scheduling portion 610, the user may select the different times in which to issue the news release. Although not limited to this embodiment, the user may select either “Hold,” which holds the news release from scheduling, “Immediate” which immediately issues the news release, or “Scheduled” which allows the user to set a specific date and time in which to issue the news release.

In the EDGAR filing scheduling portion 620, the user may select different times in which to submit the EDGAR filing. Although not limited to this embodiment, the user may select either “Hold,” which holds the EDGAR filing from scheduling, “Immediate” which immediately files the EDGAR filing, “Scheduled” which allows the user to set a specific data and time in which to file the EDGAR filing, and “Scheduled with News Release” which allows the user to schedule the EDGAR filing to be simultaneously filed with the news release. It should be appreciated that the user may select the same time when choosing the “Scheduled” option in both the news release scheduling portion 610 and the EDGAR filing scheduling portion 620, and may select a different time as well.

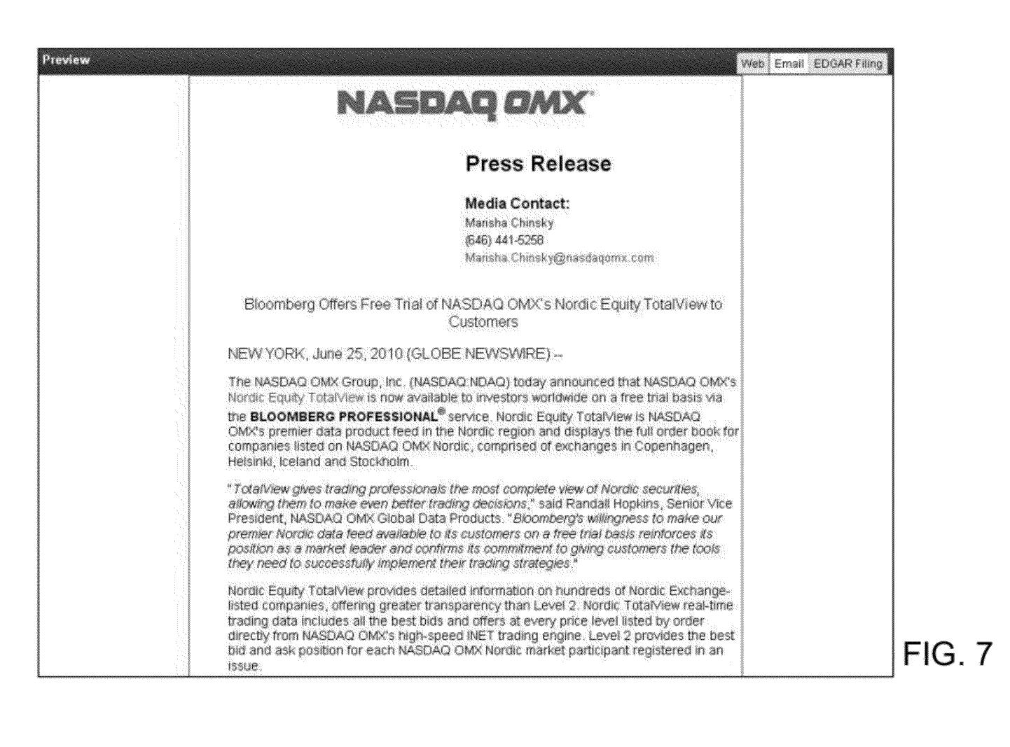

FIG. 7 shows an example of a press release that is distributed across the one or more news release distribution channels. The press release may also be submitted as an exhibit to be filed with the EDGAR filing.

While the technology has been described in connection with example embodiments, it is to be understood that the claims are not limited to the disclosed embodiments, but on the contrary, are intended to cover various modifications and equivalent arrangements.

What is claimed is:

1. An electronic filing method for performing an EDGAR filing while issuing a news release, the electronic filing method comprising:
generating a news release disclosing an event related to an organization, the news release containing a material disclosure;
scheduling an issuance of the news release to a news release distribution channel;
generating a description of contents of the news release to be placed in an EDGAR filing; and
filing the EDGAR filing while issuing the news release to the news release distribution channel,
wherein at least one of the steps is executed using a processor.

2. The electronic filing method of claim 1, wherein the EDGAR filing is filed simultaneously with the issuance of the news release.

3. The electronic filing method of claim 1, wherein the EDGAR filing is scheduled to file at a first selected time and the issuance of the news release is scheduled to issue at a second selected time, the first selected time being different from the second selected time.

4. The electronic filing method of claim 1, wherein a copy of the news release is attached to the EDGAR filing as an exhibit.

5. The electronic filing method of claim 1, wherein the EDGAR filing includes an item category and item text, the item category being one of several predefined category codes and the item text being one or more paragraphs containing the description of the contents of the news release.

6. The electronic filing method of claim 1, wherein the news release contains at least one of a release text, or classification codes, or keywords, or a combination thereof.

7. The electronic filing method of claim 5, wherein each EDGAR filing is generated based on a template for a type of EDGAR filing, the template being automatically customized based on the item category and the template being populated with the item text.

8. A non-transitory computer-readable storage medium having computer readable code embodied therein for executing the electronic filing method of claim 1.

9. An electronic filing apparatus comprising:
a memory configured to store a news release and a description of the contents of the news release; and
electronic circuitry, coupled to the memory, for performing an EDGAR filing while issuing the news release and configured to:
generate the news release disclosing an event related to an organization, the news release containing a material disclosure;
schedule an issuance of the news release to a news release distribution channel;
generate the description of the contents of the news release to be placed in an EDGAR filing; and
file the EDGAR filing while issuing the news release to the news release distribution channel.

10. The electronic filing apparatus of claim 9, wherein the electronic circuitry is configured to file the EDGAR filing and issue the news release simultaneously.

11. The electronic filing apparatus of claim 9, wherein the electronic circuitry is configured to file the EDGAR filing at a first selected time and configured to issue the news release at a second selected time, the first selected time being different from the second selected time.

12. The electronic filing apparatus of claim 9, wherein the electronic circuitry is configured to attach a copy of the news release to the EDGAR filing as an exhibit.

13. The electronic filing apparatus of claim 9, wherein the EDGAR filing includes an item category and item text, the item category being one of several predefined category codes and the item text being one or more paragraphs containing the description of the contents of the news release.

14. The electronic filing apparatus of claim 9, wherein the news release contains at least one of a release text, or classification codes, or keywords, or a combination thereof.

15. The electronic filing apparatus of claim 13, wherein the electronic circuitry is configured to generate each EDGAR filing based on a template for a type of EDGAR filing, the template being automatically customized based on the item category and the template being populated with the item text.

16. An electronic SEC filing apparatus, comprising:
a memory configured to store a news release and a description of the contents of the news release; and
a data processor coupled to the memory and configured to:
generate the news release disclosing an event related to an organization, the news release containing a material disclosure;
select one or more recipients to receive the news release;
select one or more news release distribution channels to distribute the news release;
schedule a distribution of the news release to the one or more news release distribution channels;
generate the description of the contents of the news release to be placed in an SEC filing; and
simultaneously file the SEC filing while distributing the news release to the one or more news release distribution channels.

17. The electronic filing apparatus of claim 16, wherein the data processor is configured to attach a copy of the news release to the SEC filing as an exhibit.

18. The electronic filing apparatus of claim 16, wherein the SEC filing includes an item category and item text, the item category being one of several predefined category codes and the item text being one or more paragraphs containing the description of the contents of the news release.

19. The electronic filing apparatus of claim 16, wherein the news release contains at least one of a release text, or classification codes, or keywords, or a combination thereof.

20. The electronic filing apparatus of claim 18, wherein the data processor is configured to generate each SEC filing based on a template for a type of SEC filing, the template being automatically customized based on the item category and the template being populated with the item text.
